(19) United States
(12) Patent Application Publication
(10) Pub. No.: US 2010/0171022 A1
(43) Pub. Date: Jul. 8, 2010

(54) Support structure and exposure apparatus

(75) Inventors: Norihiko Fujimaki, Fukaya-shi (JP); Takahide Kamiyama, Tokyo (JP); Hideaki Sakamoto, Fukaya-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/458,865

(22) Filed: Jul. 24, 2009

Related U.S. Application Data
(63) Continuation of application No. PCT/JP2008/051070, filed on Jan. 25, 2008.

(30) Foreign Application Priority Data
Jan. 26, 2007 (JP) P2007-016194

(51) Int. Cl. F16M 13/00

(52) U.S. Cl. 248/559

(57) ABSTRACT

A support structure supports support objects. The support structure comprises a resonance apparatus that resonates with air vibrations transmitted from the exterior to damp the air vibrations.

### CROSS-REFERENCE TO RELATED APPLICATION

This is a Continuation Application of International Application No. PCT/JP2008/051070, filed Jan. 25, 2008, which claims priority to Japanese Patent Application No. 2007-016194 filed on Jan. 26, 2007. The contents of the aforementioned applications are incorporated herein by reference.

### BACKGROUND

1. Field of the Invention

The present invention relates to a support structure and an exposure apparatus.

2. Description of Related Art

In the lithography process, which is one of the manufacturing processes for devices such as semiconductor devices, liquid crystal display elements, image pickup apparatuses (CCD, etc. (charge coupled devices)), thin-film magnetic heads, etc., an exposure apparatus is used to transfer expose a pattern formed on a reticle (or photomask, etc.) as a mask to a wafer (or a glass plate, etc.) that has been coated with a photoresist as a substrate. Full-field exposure type (static exposure type) projection exposure apparatuses such as steppers or scanning exposure type projection exposure apparatuses (scanning type exposure apparatuses), etc. such as scanning steppers are used as the exposure apparatus.

In these exposure apparatuses, miniaturization of a circuit pattern formed-on a wafer is required in conjunction with higher integration of semiconductor devices, etc. In recent years, the line width of the circuit pattern is 40 to 50 nm.

In order to achieve miniaturization of circuit patterns, it is necessary to eliminate the effects of vibration as much as possible in order to improve exposure accuracy. In conventional exposure apparatuses, for example, external vibration is restricted from being transmitted to projection optical systems, etc. by installing a support structure, etc. that supports a projection optical system via a vibration isolating stage (for example, see Japanese Patent Application Publication No. 2006-70928A).

In recent years, circuit pattern line widths are required on the order of 40 to 50 nm as discussed above, and, in the future, further miniaturization of circuit patterns will progress. For this reason, a need to perform further removal of the effects of vibration will come about.

Conventional exposure apparatuses are such that countermeasures are implemented with respect to vibration transmitted via the housing and the support structure, but countermeasures to air vibrations such as noise propagated through spaces are not implemented. In the case in which the frequency of air vibrations such as noise is matched to the natural frequency of the installed member, there is concern that said member will resonate and vibrate, causing exposure accuracy to deteriorate.

For example, noted in PCT International Publication No. WO 02/101804 is an exposure apparatus in which the exposure apparatus main body is accommodated within the chamber and that forms an air-conditioning space at the interior of that chamber. In such an exposure apparatus, an air circulation path for forming the aforementioned air-conditioning space is provided, and a blower is installed along circulation path. There is a possibility that the noise generated from this blower will be such that vibrations of a specific frequency are intensified while being propagated through the circulation path, etc. For example, in the case in which the intensified specific frequency has matched the natural frequency of a member that comprises an interferometer, there is concern that vibration will occur due to that member resonating, causing measurement error to be produced.

For this reason, it is thought that in the future there will be a need to implement countermeasures for such air vibrations.

A purpose of some aspects of the present invention is to provide a support structure and an exposure apparatus that are able to restrict vibrations produced attributable to air vibrations.

### SUMMARY

Provided according to a first aspect of the present invention is a support structure that supports a support object and comprises a resonance apparatus that resonates with air vibrations transmitted from the exterior to damp the air vibrations.

According to the first aspect, the air vibrations are damped by the resonance apparatus resonating with air vibrations transmitted from the exterior.

Provided according to a second aspect of present invention is an exposure apparatus that exposes the image of a pattern to a substrate using a support object supported by a support structure; wherein it uses a support structure of the present invention as the support structure.

According to some aspects of the present invention, air vibrations are damped by the resonance apparatus resonating with the air vibrations transmitted from the exterior, so, even in the case in which the frequency of the air vibrations matches the natural vibration frequency of a specific member, it is possible to restrict vibrations of a specific member.

Therefore, according to the modes of the present invention, it is possible to restrict vibrations produced attributable to air vibrations.

### BRIEF DESCRIPTION OF THE DRAWINGS

FIG. 1 is a schematic view that shows the configuration of an exposure apparatus of the first embodiment of the present invention.

FIG. 2 is cross-sectional view of columns comprised by an exposure apparatus of the first embodiment of the present invention.

FIG. 3 is a cross-sectional view of a resonance apparatus comprised by an exposure apparatus of the first embodiment of the present invention.

FIG. 4 is an exploded view of a resonance apparatus comprised by an exposure apparatus of the first embodiment of the present invention.

FIG. 5 is an explanatory drawing for describing Helmholtz resonance.

FIG. 6 is an explanatory drawing for describing a specific method of adjusting the capacity of the space of a resonance apparatus comprised by an exposure apparatus of the first embodiment of the present invention.

FIG. 7 is an explanatory drawing for describing a specific method of adjusting the capacity of the space of a resonance apparatus comprised by an exposure apparatus of the first embodiment of the present invention.

FIG. 8 is an explanatory drawing for describing a specific method of adjusting the capacity of the space of a resonance apparatus comprised by an exposure apparatus of the first embodiment of the present invention.

FIG. 9 is an explanatory drawing for describing a specific method of adjusting the capacity of a space A of a resonance apparatus comprised by an exposure apparatus of the first embodiment of the present invention.

FIG. 10 is an explanatory drawing for describing a specific method of adjusting the length and cross-sectional area of a narrow path of a resonance apparatus comprised by an exposure apparatus of the first embodiment of the present invention.

FIG. 11 is a schematic view of the configuration of stage exhaust parts provided on a wafer stage comprised by an exposure apparatus of the first embodiment of the present invention.

FIG. 12 is a cross-sectional view of columns comprised by an exposure apparatus of the second embodiment of the present invention.

FIG. 13 is an explanatory drawing for describing the arrangement method of a resonance apparatus of an exposure apparatus of the second embodiment of the present invention.

FIG. 14 is a cross-sectional view of a column comprised by an exposure apparatus of the third embodiment of the present invention.

FIG. 15 is an explanatory drawing for describing the arrangement method of a resonance apparatus of an exposure apparatus of the third embodiment of the present invention.

FIG. 16 is a cross-sectional view of a column comprised by an exposure apparatus of the fourth embodiment of the present invention.

FIG. 17 is a flow chart that shows an example of a microdevice manufacturing process.

FIG. 18 is a drawing that shows an example of the detailed process of step S13 of FIG. 17.

### DESCRIPTION OF EMBODIMENTS

An embodiment of the support structure and the exposure apparatus relating to the present invention will be described below while referring to drawings. Note that, in the following drawings, the scale of reduction of the respective members has been appropriately changed in order to make the respective members a recognizable size. In addition, in the following description, an XYZ rectangular coordinate system has been set up, and there are cases in which descriptions of the positional relationships of the respective members are given while referring to this XYZ rectangular coordinate system. Also, prescribed directions within the horizontal plane are considered the X axis directions, directions orthogonal to the X axis directions within the horizontal plane are considered the Y axis directions, and directions respectively orthogonal to the X axis directions and the Y axis directions (specifically, the vertical directions) are considered the Z axis directions.

### First Embodiment

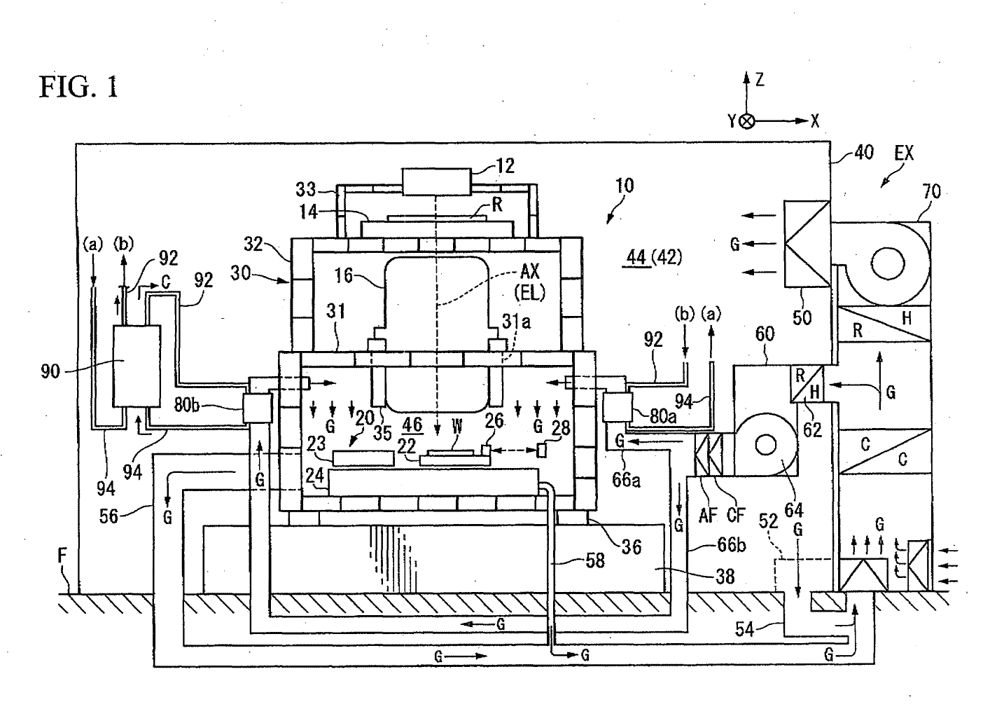

FIG. 1 is a schematic view that shows the configuration of an exposure apparatus EX of the first embodiment.

The exposure apparatus EX is a step-and scan type system scanning type exposure apparatus, specifically, a so-called scanning stepper, that synchronously moves a reticle R and a wafer W in one-dimensional directions while transferring a pattern formed on the reticle R to the respective shot regions on the wafer W via a projection optical system 16.

The exposure apparatus EX comprises an exposure apparatus main body 10, a main body chamber 40, which is installed on a floor F within a clean room and accommodates the exposure apparatus main body 10, and a machine chamber 70, which is arranged adjacently to the main body chamber 40.

The exposure apparatus main body 10 comprises an illumination optical system 12, which illuminates a reticle R by means of exposure light EL, a projection optical system 16, which projects the exposure light EL irradiated from the reticle R onto the wafer W, a wafer stage 20, which holds the wafer W and is able to move, a column 30 (support structure), which holds the projection optical system 16 and the illumination optical system 12, etc. and on which the reticle stage 14 and the wafer stage 20 are mounted, and a control apparatus, etc. (not shown) that comprehensively controls the exposure apparatus EX.

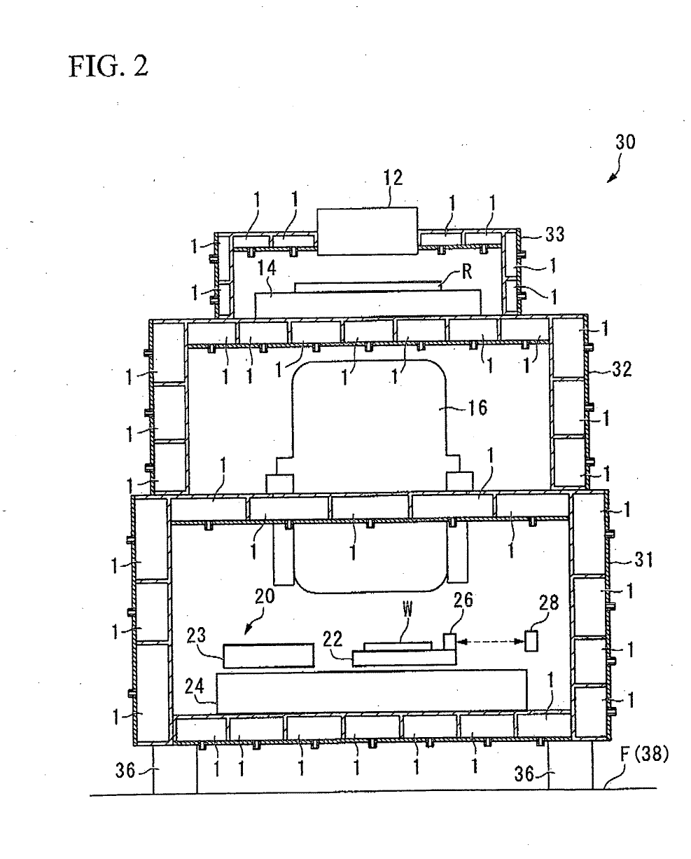

FIG. 2 is a cross-sectional view of a column 30. Note that, in FIG. 2, for convenience of description, elements other than the column 30, the illumination optical system 12, the reticle stage 14, the projection optical system 16, the wafer stage 20, vibration isolating stages 36 and the floor F have been omitted.

The column 30 comprises a main column 31, which is supported on a base plate 38 installed on the floor F via a vibration isolating stage 36 and supports the projection optical system 16 (support object) and the wafer stage 20, etc., and a first support column 32, which is installed on the main column 31 and supports the reticle stage 14 (support object), and a second support column 33, which is installed on the first support column 32 and supports the illumination optical system 12 (support object).

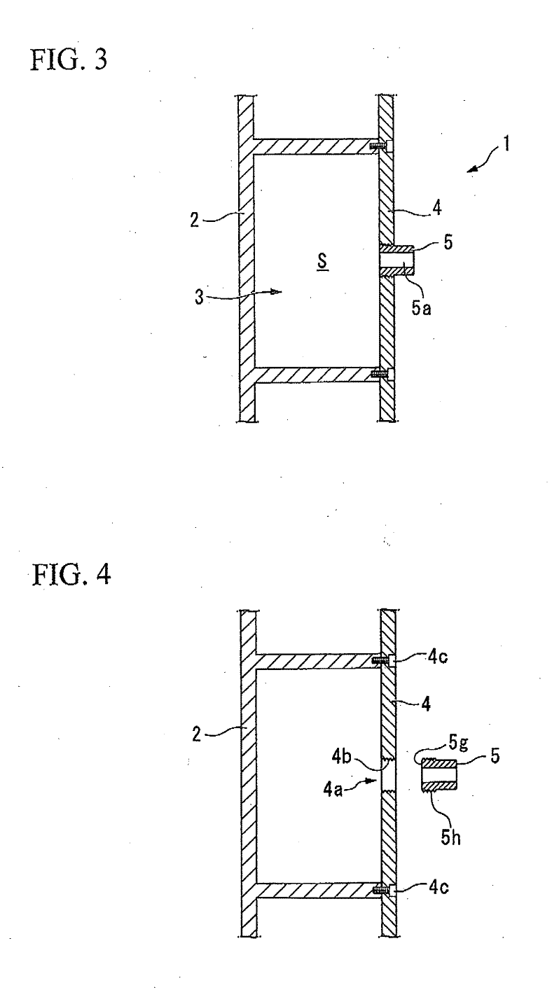

The main column 31, the first support column 32 and the second support column 33, that is, column 30, comprise a plurality of resonance apparatuses 1. The resonance apparatus 1, as shown in the cross-sectional view of FIG. 3, resonates with air vibrations transmitted from the exterior by means of Helmholtz resonance to damp the air vibrations. This resonance apparatus 1 is comprised by a recessed part 3 formed on a column main body 2, which is a cast metal member, a lid part 4, which covers the recessed part 3, and an orifice 5 (neck part) that has a narrow path 5a that connects the space S covered by the lid part 4 with an external space.

Note that “narrow path” refers to a passageway. In the present embodiment, the narrow path functions as a flow passageway for air to exit and enter between the space S and an external space.

As shown in FIG. 4, the lid part 4 is a plate-shaped member and has a through hole 4a in which a female screw 4b is formed. In addition, the lid part 4 is secured to the column main body 2 by means of screws 4c.

The orifice 5 is a tube-shaped member 5, and a male screw 5h is formed at one end part side 5g. In addition, the orifice 5 is fixed to the lid part 4 by means of the male screw 5h threading with the female screw 4b formed in a through hole 4a of the lid part 4.

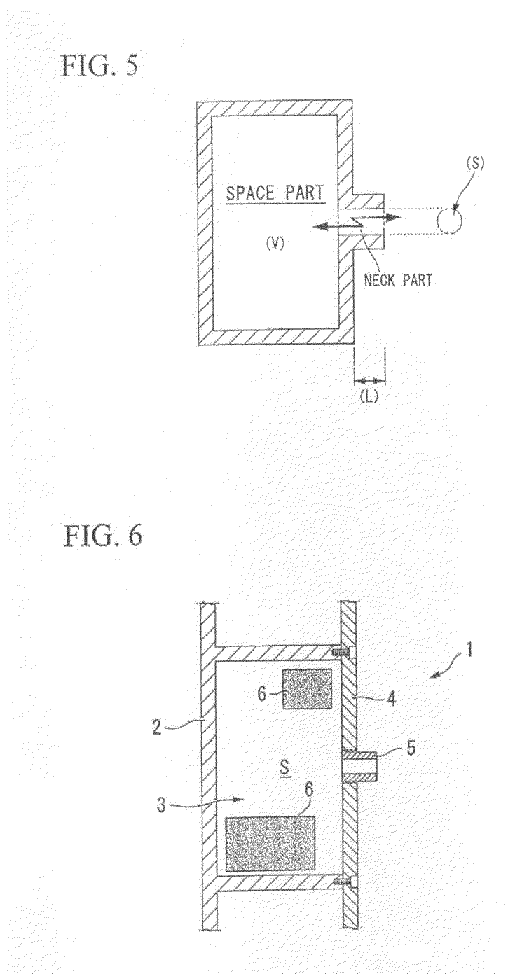

FIG. 5 is an explanatory drawing for describing Helmholtz resonance and is a schematic view that shows a Helmholtz resonator.

It is a Helmholtz resonator in which a neck part is connected to a space part, and a spring mass system in which the air of the space part acts as a spring, and the air of the neck part acts as a mass is conceivable. The resonant frequency f of the Helmholtz resonance is expressed by Equation (1) below when the sonic velocity is c, the capacity of the space part is V, the length of the neck part is L, and the cross-sectional area of the neck part is S.

$$\begin{matrix}Equation 1 & \\ f = \frac{c}{2 π} \sqrt{\frac{S}{VL}} & ( 1 )\end{matrix}$$

Specifically, as shown in Equation (1), in a Helmholtz resonator, in the case in which a periodic external force identical to the frequency f is applied from the exterior, specifically, in the case in which air vibrations of frequency f have been transmitted, the air of the interior is vibrated.

This is the Helmholtz resonance principle. The energy of air vibrations of frequency f is consumed by the frictional force, etc. produced by the air of the interior of the Helmholtz resonator vibrating, and, as a result, the amplitude of the air vibrations is reduced. Specifically, air vibrations of the same frequency as the resonant frequency f are damped by means of the Helmholtz resonator.

In the exposure apparatus EX of the present embodiment, the space S formed by the recessed part 3 formed in the column main body 2 being covered by the lid part 4 functions as the space part of the Helmholtz resonator, and the resonator apparatus 1 functions by means of the narrow path 5a that the orifice 5 functions as the neck part of the Helmholtz resonator (see FIG. 3).

Equation (1) above is comprised with the Helmholtz resonator's capacity V of the space part, length L of the neck part and cross-sectional area S of the neck part as variables. For this reason, by adjusting these variables, it is possible to comprise a Helmholtz resonator that has any resonant frequency f.

Specifically, in the present embodiment, the resonance apparatus I has a resonant frequency that matches the frequency F of the air vibrations due to the fact that at least one of the space S (capacity V) and the narrow path 5a (length L, cross-sectional area S) is formed by using specifications according to the frequency F of the air vibrations to be damped.

Note that, in the present embodiment, it is preferable that the resonant frequency f of the resonance apparatus 1 be set, for example, to the natural frequency of laser interferometer 28 (see FIG. 1) to be discussed later.

Here, the specific method of adjusting the capacity of the space S will be described while referring to FIG. 6 to FIG. 9.

For example, as shown in FIG. 6, it is possible to adjust the capacity of the space S by filling a part of the space S by means of an adjustment member 6 for adjusting the capacity of the space S. It is possible to use a glass wall, etc. as such an adjustment member 6. Note that the adjustment member 6 is arranged at the interior of the space S by being arranged in the interior of the recessed part 3 prior to covering the recessed part 3 by means of the lid part 4.

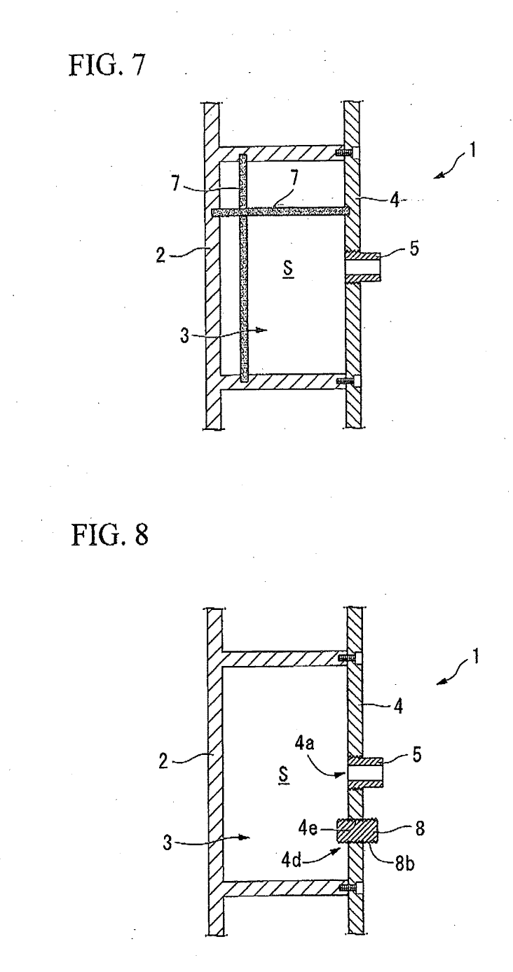

In addition, as shown in FIG. 7, it is possible to adjust the capacity of the space S by partitioning a part of the space S by means of a partition plate 7 (adjustment member). Such a partition plate 7 is arranged at the interior of the space S by fixing within the recessed part 3 prior to the recessed part 3 being covered by the lid part 4.

In addition, as shown in FIG. 8, the capacity of the space S can be adjusted by an insertion member 8 that is able to adjust the amount of insertion to the space S. The insertion member 8 is such that a male screw 8b is formed at the entirety of or at one end part side (in FIG. 8, the entirety), and it threads into a through hole 4d formed in the lid part 4 separately from through hole 4a. Note that a female screw 4e is formed in through hole 4d. The insertion member 8 moves out and in by means of the insertion member 8 rotating to the right or rotating to left, and the capacity of the space S is adjusted thereby.

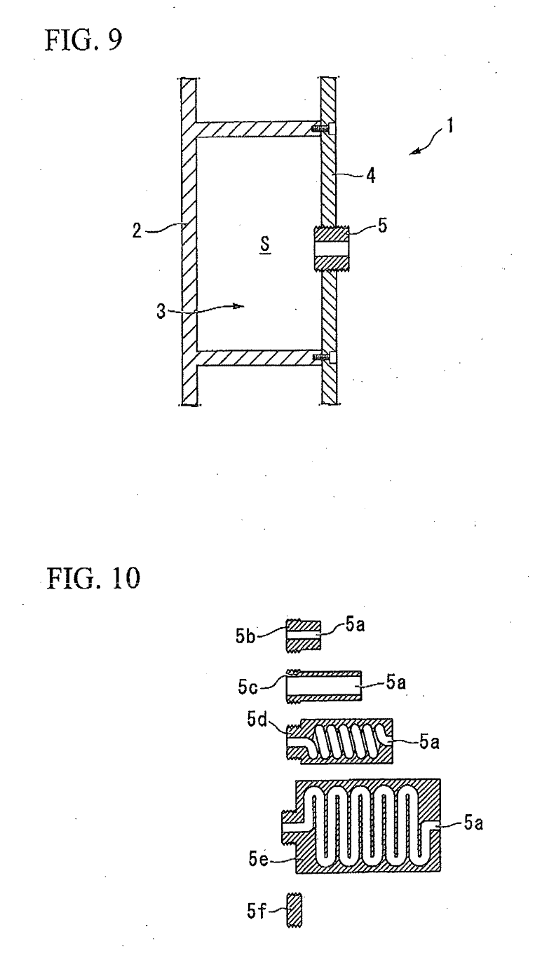

In addition, as shown in FIG. 9, a male screw 4f is formed in the entirety of the orifice 5, and it is possible to adjust the amount of insertion to the space S of the orifice 5 itself; specifically, by forming the insertion member shown in FIG. 8 as a unit with the orifice 5, it is possible to adjust the capacity of the space S. In such a case, it is preferable that the orifice 5 be formed thick so that the capacity of the space S changes adequately by changing the amount of insertion of the orifice 5.

Next, a specific method of adjusting the length and cross-sectional area of the narrow path 5a will be described while referring to FIG. 10.

In the manner discussed above, the orifice 5 is fixed to the lid part 4 by threading into through hole 4a (see FIG. 3). For this reason, the orifice 5 is made easily removable. Specifically, the orifice 5 is freely attachably and removably fixed to the lid part 4. Therefore, as shown in FIG. 10, orifices 5b to 5e, in which the lengths and cross-sectional areas of the narrow path 5a differ, are prepared in advance, and it is possible to adjust the length and the cross-sectional area of the narrow path 5a by selecting these orifices 5 and attaching them to the lid part 4.

Note that, in the case in which the length of the narrow path 5a is long, as in the case of orifices 5d and 5e, the narrow path 5a may also be made to be serpentine. By causing the narrow path 5a to be serpentine in this way, it is possible to restrict the amount of protrusion of the orifice 5 from the lid part 4.

Note that, in the case in which it is not desired that the space S be caused to function as a resonance apparatus 1, the plug 5f shown in FIG. 10 may be attached to the lid part 4 to cover the through hole 4a.

Note that, in order to prevent the orifice 5 and the insertion member 8 from becoming separated, after the capacity of the space S and the length and cross-sectional area of the narrow path 5a have been determined using specifications according to the frequency F of the air vibrations to be damped, for example, it is preferable to use a screw lock agent, etc. to fix the orifice 5 and the insertion member 8 to the lid part 4.

Note that an example was given with regard to the narrow path 5a of the orifice 5 having its length and cross-sectional area varied while having a uniform inner diameter, but it is not absolutely necessary for the internal diameter to be uniform. For example, one may also aim for an effect of varying the length and the cross-sectional area by partially varying the internal diameter.

Returning to FIG. 1, the illumination optical system 12 illuminates a reticle R supported by a reticle stage 14 using exposure light EL, and it has an optical integrator, which makes the illumination intensity of the exposure light EL that emerges from an exposure light source that is not shown uniform, a condenser lens, a relay lens system, and a variable field stop, etc., which sets the illumination region on the reticle R resulting from the exposure light EL in a slit shape (none of which are shown).

In such a configuration, the illumination optical system 12 is able to illuminate a prescribed illumination region on the reticle R using an exposure light EL with a more uniform illumination intensity distribution.

Note that used as the exposure light EL that emerges from the exposure light source are, for example, ultraviolet light such as ultraviolet range bright lines (g lines, h lines, i lines) that emerge from a mercury lamp, KrF excimer laser light (wavelength of 248 nm), and ArF excimer laser light (wavelength of 193 nm).

The reticle stage 14 supports the reticle R and performs two-dimensional movement and slight rotation within a plane orthogonal to the optical axis AX of the projection optical system 16. Note that the reticle R is vacuum chucked by means of a reticle chucking mechanism provided in the vicinity of a rectangular aperture formed on the reticle stage 14.

Note that it may also be such that the reticle R is able to move in the direction of the optical axis AX or in the optical axis direction of the exposure light EL irradiated to the reticle R.

The position and amount of rotation of the reticle R on the reticle stage 14 in the two-dimensional direction is measured in real-time by a laser interferometer that is not shown, and the measurement result thereof is output to the control apparatus. Positioning of the reticle R supported by the reticle stage 14 is performed by the control apparatus driving a linear motor, etc. based on the measurement results of a laser interferometer.

Note that the reticle stage 14 is supported by the first support column 32.

The projection optical system 16 projection-exposes a pattern formed on the reticle R onto the wafer W at a prescribed projection magnification, and it is configured by a plurality of optical elements. In the present embodiment, the projection optical system 16 is a reduction system in which the projection magnification β is, for example, ¼ or ⅕. Note that the projection optical system 16 may also be any of a reduction system, a unity magnification system or an enlargement system.

The projection optical system 16 is inserted into and is supported in a hole part 31a provided in the ceiling of the main column 31 via a sensor column 35. Note that an FA sensor, etc. that is not shown is installed in the sensor column 35.

The wafer stage 20 comprises an XY table 22, which holds a wafer W and is able to move in directions with three degrees of freedom, which are the X directions, the Y directions and the AZ directions, and a wafer base plate 24, which movably supports the XY table 22 within the XY plane. Also comprised is a measurement table 23, which mounts another wafer during exposure processing of the wafer W mounted on the XY table 22 to perform alignment processing, etc.

A movable mirror 26 is provided on the wafer stage 20, and a laser interferometer 28 is provided at a position in opposition thereto. The position and amount of rotation of the wafer stage 20 in the two-dimensional directions is measured in real-time by a laser interferometer 28, and the measurement result is output to the control apparatus. The position and movement velocity, etc. of the wafer W held by the wafer stage 20 is controlled by the control apparatus driving a linear motor, etc. based on the measurement results of the laser interferometer 28.

Note that stage exhaust parts 110, which recover air G and return it to the machine chamber 70, are formed in the wafer base plate 24. The details will be discussed later.

The main body chamber 40 is formed to have an exposure chamber 42, in which environmental conditions (degree of cleanliness, temperature, pressure, etc.) are maintained to be nearly constant, and a reticle loader chamber and a wafer loader chamber that are not shown and are arranged at the side part of this exposure chamber 42. Note that the exposure chamber 42 is such that the exposure apparatus main body 10 is arranged in the interior thereof.

An injection port 50, which is connected to the machine chamber 70 and supplies temperature regulated air (gas) A to the interior of the main body chamber 40 is provided at the upper part side surface of the exposure chamber 42. The temperature regulated air G fed from the machine chamber 70 is fed into an upper part space 44 of the exposure chamber 42 by side flow from the injection port 50.

In addition, a return part 52 is provided at the bottom part of the exposure chamber 42, and one end of a return duct 54 is connected below this return part 52. The other end of the return duct 54 is connected to the machine chamber 70.

In addition, a return duct 56 is connected to a plurality of locations of the lower end side surface and bottom surface of the main column 31, and the other end of this return duct 56 is connected to the machine chamber 70. Specifically, though a drawing has been omitted, the return duct 56 comprises a plurality of branching paths, and these branching paths are connected at a plurality of locations of the lower end side surface and bottom surface of the main column 31.

Specifically, these are such that the air G within the exposure chamber 42 is returned from the return part 52, etc. to the machine chamber 70 via return ducts 54 and 56.

An air supply conduit 60, which is connected to the machine chamber 70, is connected to the side surface of the exposure chamber 42 and is also provided to extend into the exposure chamber 42. A heater 62, a blower 64, a chemical filter CF, and a filter box AF are sequentially arranged in the interior thereof.

Furthermore, the air supply conduit 60 is branched to two branching paths 66a, 66b. One of the branching paths 66a is connected to the inner side space 46 of the main column 31 via a temperature stabilization flow passageway apparatus 80a. The other branching path 66b is connected to the inner side space 46 of the main column 31 via a temperature stabilization passageway apparatus 80b.

Note that temperature stabilization flow passageway apparatuses 80a and 80b are apparatuses that further regulate the temperature of the air G with high accuracy by performing heat exchange with the air G sent from the air supply conduit 60. For the temperature stabilization flow passageway apparatus, it is possible to use, for example, that disclosed in Published Japanese Translation No. 2002-101804 of PCT International Application.

A temperature regulation apparatus 90 is connected to the respective temperature stabilization flow passageway apparatuses 80a, 80b via a supply conduit 92 and an exhaust conduit 94. Through this, a temperature regulation medium C circulation path comprising the temperature regulation apparatus 90, the supply conduit 92, the temperature stabilization flow passageway apparatuses 80a, 80b, and the exhaust conduit 94 is configured.

In addition, Fluorinate®, for example, is used as the temperature regulation medium C, and temperature regulation to an approximately constant temperature is performed by the temperature regulation apparatus 90. Through this, temperature stabilization flow passageway apparatuses 80a and 80b have their temperatures maintained to be constant. It is also possible to use hydrofluoroether (HFE) or water as the temperature regulation medium C.

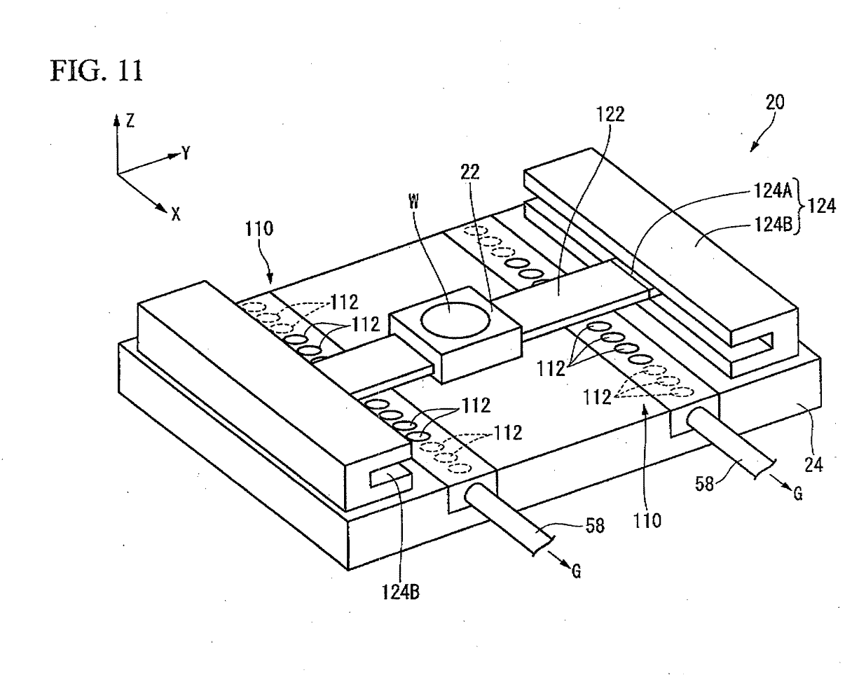

FIG. 11 is a schematic view that shows the configuration of a stage exhaust part 110 provided on the wafer stage 20.

As discussed above, the wafer stage 20 comprises an XY table 22 and a wafer base plate 24, and the XY table 22 is supported without contact on the wafer base plate 24 via air bearings that are not shown.

An opening that pierces through in the Y directions is provided at the side surface of the XY table 22, and a Y guide bar 122 that serves as a Y linear motor is provided to extend in that opening. Specifically, the XY table 22 is configured to be guidable in the Y directions along the Y guide bar 122.

In addition, a pair of linear motors 124, which greatly move the XY table 22 in the X directions, is arranged at the two ends of the wafer stage 20 in the Y directions.

The linear motor 124 is configured by a combining movers 124A, which are arranged at the two ends of the Y guide bar 122 and accommodate coil windings, and stators 124B, which comprise plate-shaped permanent magnets that face the Z direction surfaces of the movers 124A and are arranged in a layered manner in the X directions.

As shown in FIG. 11, a pair of stage exhaust parts 110, which have a plurality of exhaust ports 112, is arranged on the wafer base plate 24.

The stage exhaust parts 110 are arranged so as to be inserted into recessed grooves (not shown) formed along the X directions at the inner sides of the linear motors 124 on the wafer base plate 24. Specifically, the stage exhaust parts 110 are arranged in regions other than the moving region of the XY table 22 on the wafer base plate 24 and the arrangement region of the linear motors 124.

Return ducts 58 are respectively connected to the X direction side surfaces of the respective stage exhaust parts 110. These return ducts 58 are connected to return ducts 56 (see FIG. 1). Through this, the air G in the vicinity of the wafer stage 20 is fed to the interior of the stage exhaust parts 110 from a plurality of exhaust ports 112 formed on the wafer base plate 24 and is returned to the machine chamber 70 via return ducts 58 and 56.

In addition, the respective exhaust ports 112 of the stage exhaust parts 110 are connected by means of solenoid valves that are not shown so that opening and closing are possible. In this way, the reason that the exhaust ports 112 are comprised so that opening and closing are possible is to make the exhaust ports 112, which open to coincide with movement of the XY table 22, selectable. In other words, this is so the flow of the air G in the vicinity will not be disturbed even if the XY table 22 moves.

Next, the actions of the exposure apparatus EX will be described.

First, the machine chamber 70 is operated by the control apparatus, and temperature regulated air G is fed toward the exposure chamber 42. Through this, inside the exposure chamber 42, temperature regulated air G is fed to the upper part space 44 of the exposure chamber 42 from the injection port 50 by means of even side flow.

In addition, the blower 64 is operated by the control apparatus, and temperature regulated air G is fed to the interior space 46 of the main column 31 via branching paths 66a and 66b.

Then, the air G that has been fed into the stage space 46b is exhausted by return duct 58 from the stage exhaust parts 110, is exhausted to return duct 56 from the lower end side surface, etc. of the main column 31 and is returned to the machine chamber 70.

In addition, the air G that has been fed into the exposure chamber 42 is exhausted by the return duct 54 and is returned to the machine chamber 70.

Through this, the interior space 46 of the exposure chamber 42 and the main column 31 is air-conditioned.

In the case in which the interior space 46 of such an exposure chamber 42 and main column 31 is air-conditioned, the machine chamber 70 and the blower 64 are operated in the manner discussed above. Noise, and specifically, air vibrations, in a broad frequency band are generated by operation of the machine chamber 70 and the blower 64.

In the present embodiment, air vibrations generated in the machine chamber 70 and the blower 64 are such that frequencies f are damped by a resonance apparatus 1 in which the resonant frequency is considered to be frequency f. Specifically, when air vibrations have reached the resonance apparatus 1, depending on frequency f component included in the air vibrations, vibration occurs due to the air of the interior of the resonance apparatus 1 resonating, the energy of the air vibrations of frequency f are consumed by the frictional force, etc. produced thereby, and, as a result, the amplitude of the frequency f included in the air vibrations is reduced and damped.

Specifically, in the case in which the resonant frequency f of the resonance apparatus 1 has been set to, for example, the natural frequency of the laser interferometer 28, air vibrations whose frequency f has been damped are transmitted to the interior space 46 of the main column 31. For this reason, even in the case in which noise produced due to operation of the machine chamber 70 and the blower 64 has been transmitted to the interior space 46 of the main column 31, it is possible to restrict the laser interferometer 28 from vibrating.

In an environment in which countermeasures with respect to such air vibrations and temperature regulation have been performed, exposure processing by means of the exposure apparatus main body 10 can be performed. Specifically, the exposure light EL that has emerged from the exposure light source, which is not shown, in an illumination optical system 12 comprising various lenses and mirrors, etc., illuminates a reticle R on which a pattern has been formed after being shaped to the required size and illumination intensity uniformity, and the pattern formed on this reticle R is reduction transferred to the respective shot regions on the wafer W held on the wafer stage 20 via the projection optical system 16. By means of this, a fine pattern is formed on the wafer W with high accuracy.

As described above, according to the exposure apparatus EX of the present embodiment, a resonance apparatus 1, in which a column 30 resonates with air vibrations transmitted from the exterior to damp the air vibrations is comprised, so the air vibrations are damped. For this reason, even in the case in which the frequency of the air vibrations matches the natural vibration frequency of a specific member (in the present embodiment, for example, the laser interferometer 28), it is possible to restrict vibration of specific members. Therefore, according to the exposure apparatus EX of the present embodiment, it is possible to restrict vibrations produced attributable to air vibrations.

In addition, since the resonance apparatus 1 is plurally comprised, it is possible to damp air vibrations transmitted from a plurality of directions.

In addition, the column main body 2 is a cast metal member, and a recessed part 3 formed in the column main body 2 comprises a part of the resonance apparatus 1. The cast metal member generally has many recessed parts at the point at which it is manufactured for convenience of the manufacturing process. In the present invention, the recessed parts formed in the cast metal member in advance are used as a part of the resonance apparatus 1, so it is not necessary to perform separate processing to form recessed parts, and it is possible to easily form the resonance apparatus 1.

Also, in the resonance apparatus 1, an orifice 5 is fixed to a lid part 4 to be freely removable and attachable, so it is possible to attach various orifices 5, such as those shown in FIG. 10, to be easily replaceable, so it is possible to easily make the resonant frequency of the resonance apparatus 1 correspond to the desired air vibration frequencies to be damped.

In addition, it is similarly possible to easily make the resonant frequency of the resonance apparatus 1 correspond to the desired air vibration frequencies to be damped by making it possible to adjust the capacity of the space S formed by the recessed part 3 being covered by the lid part 4 as discussed above.

### Second Embodiment

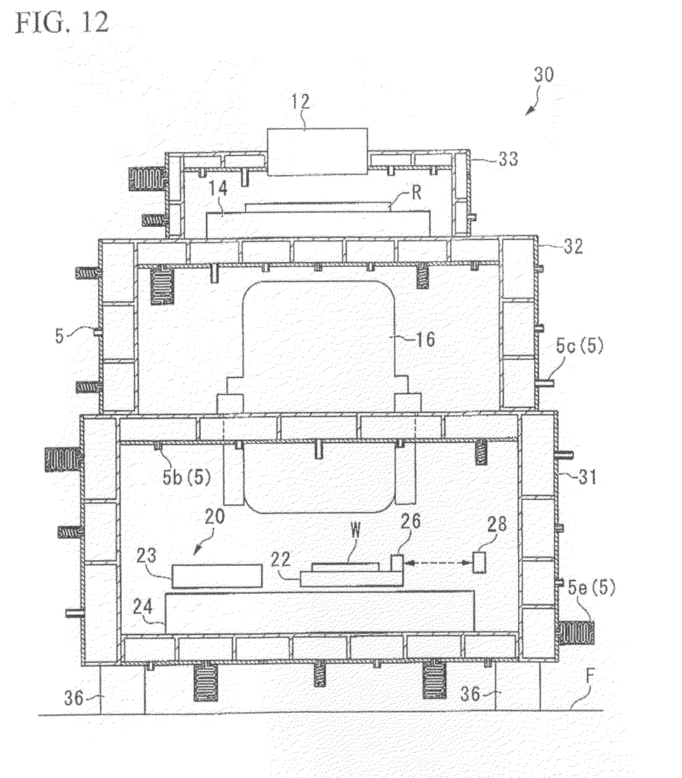

Next, a second embodiment of the present invention will be described. Note that while the above first embodiment, as shown in FIG. 2, is such that all of the resonance apparatuses 1 the column 30 has comprise orifices 5 corresponding to same type of frequency f, the second embodiment, as shown in FIG. 12, differs from the above first embodiment on the point that column 30 has resonance apparatuses 1 comprising orifices 5 corresponding to different types of frequencies. For this reason, in the description of the present embodiment, portions that are similar to those of the first embodiment above will have descriptions thereof omitted or abbreviated, and mainly the points of difference will be described.

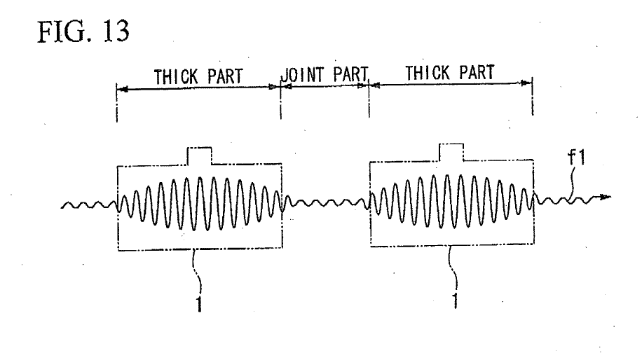

As shown in FIG. 13, when a specific frequency f1 included in air vibrations such as noise is focused on, within a prescribed space, a thick part, at which the amplitude becomes relatively large, and a joint part, at which the amplitude becomes relatively small, are present. In addition, in the case in which a specific frequency f1 is to be damped, the specific frequency f1 can be efficiently damped by installing a resonance apparatus 1 whose resonant frequency is f1 at the thick part at which the amplitude becomes relatively large as shown in FIG. 13.

In addition to the laser interferometer 28, the exposure apparatus EX comprises, as members for which it is desirable to remove effects of vibration, members such as the projection optical system 16, the XY table 22 of the wafer stage 20, the measurement table 23 of that wafer stage 20, movable mirrors 26, etc. Also, these members have respectively different natural frequencies. For this reason, it is preferable that resonance apparatuses 1 in which the resonant frequencies match the respective natural frequencies of the members for which it is desirable to remove the effects of vibration be separately installed.

In the present embodiment, in addition to making the plurality of frequencies included in the air vibrations subject to damping, the configuration is such that resonance apparatuses 1 whose resonant frequencies match the thick part of air vibrations of a prescribed frequency subject to damping are arranged by means of having appropriate orifices 5.

For this reason, according to the present embodiment, it is possible to efficiently damp the plurality of frequency components included in air vibrations of a broad frequency range, such as noise.

Note that, in the present embodiment, one in which the resonant frequency of the resonance apparatus 1 was matched to a prescribed frequency of air vibrations according to the type of orifice 5 was described, but it is not limited to this, and the resonant frequency of the resonance apparatus 1 may also be matched to the prescribed frequency of the air vibrations according to a method that adjusts the capacity of the space S comprised by the resonance apparatus 1, which was described in the above first embodiment.

### Third Embodiment

Next, a third embodiment of the present invention will be described. Note that, in the third embodiment, the configuration of the resonance apparatus 1 differs from that of the first embodiment, and the remainder is in common, so, in the description of the present embodiment, portions that are similar to those of the first embodiment above will have descriptions thereof omitted or abbreviated, and mainly the points of difference will be described.

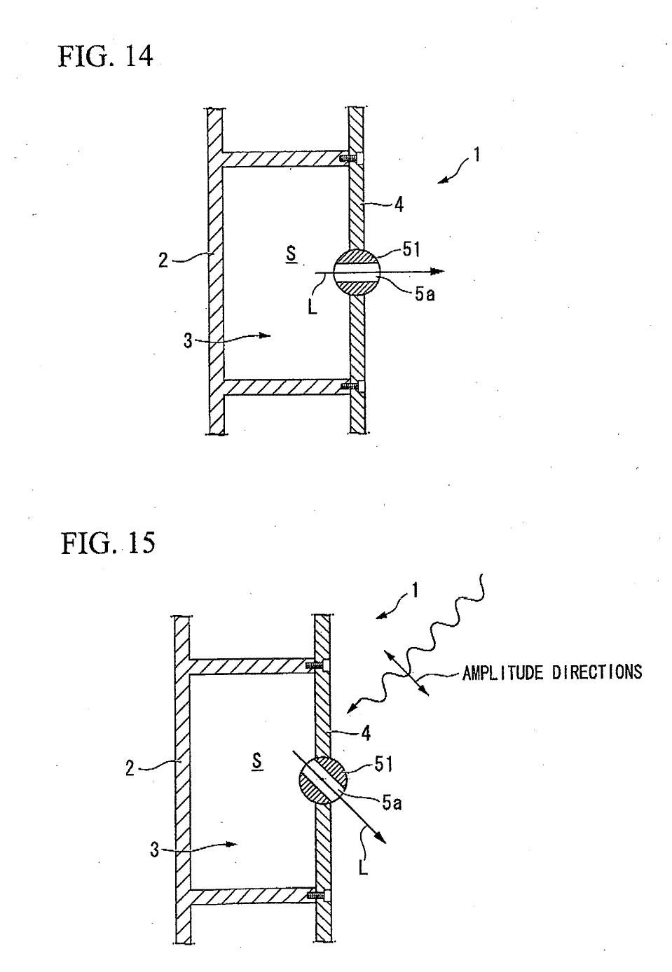

FIG. 14 is a cross-sectional view of a resonance apparatus 1 comprised by the exposure apparatus EX of the present embodiment. In this figure, the resonance apparatus 1 of the present embodiment comprises, instead of the orifice 5 of the above first embodiment, an orifice 51 whose outer shape is shaped and set to a spherical shape and that is engaged with the lid part 4 to be freely rotatable.

In the resonance apparatus 1, in the case in which the resonance apparatus 1 has resonated by means of the air vibrations, the air of the interior vibrates, and, as a result, air exits and enters via the narrow path 5a. In the case in which the direction of movement of air via this narrow path 5a matches the direction of the amplitude of the air vibrations, it is possible to more efficiently damp air vibrations.

For this reason, as shown in FIG. 15, the exposure apparatus EX of the present embodiment is one that is able to damp air vibrations more efficiently by the orifice 51 being installed with direction L of the narrow path 5a (the direction (axial direction) in which the narrow path 5a expands; the direction in which the air moves) being along the amplitude direction of the air vibrations.

In the present embodiment, the orifice 51 is fit with the lid part 4 to be freely rotatable. Specifically, the orifice 51 is such that the angle of the direction of the narrow path 5a with respect to the lid part 4 is fixed to be freely variable. For this reason, it is possible to easily change the direction L of the narrow path 5a, and it is possible to easily match the direction L of the narrow path 5a to the amplitude direction of the air vibrations.

Note that, after the direction L of the narrow path 5a has been determined, the orifice 51 may be fixed to the lid part 4 using a bonding agent, etc. so that direction L of the narrow path 5a does not shift.

### Fourth Embodiment

Next, a fourth embodiment of the present invention will be described. Note that, in the fourth embodiment, the configuration of the resonance apparatus 1 differs from that of the first embodiment, and the remainder is in common, so, in the description of the present embodiment, portions that are similar to those of the first embodiment above will have descriptions thereof omitted or abbreviated, and mainly the points of difference will be described.

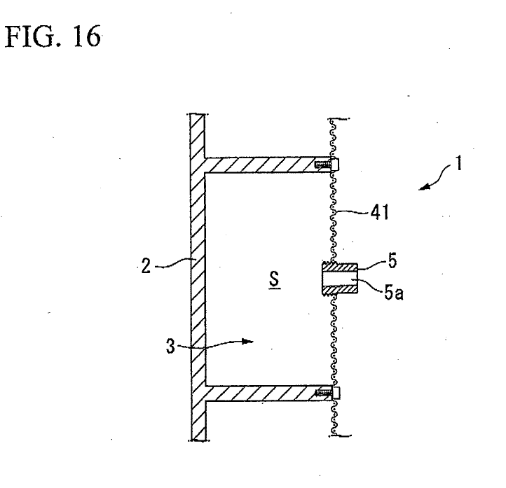

FIG. 16 is a cross-sectional view of the resonance apparatus 1 that the exposure apparatus EX of the present embodiment has. As shown in this figure, the resonance apparatus 1 of the present embodiment comprises a lid part 41 comprising a film-shaped part instead of the lid part 4 of the above first embodiment.

In the Helmholtz resonator shown in FIG. 5, in the case in which the rigidity of the wall part that forms the space part is high, capacity variation of the space part accompanying air vibrations of the interior is not produced. For this reason, the Helmholtz resonator strongly damps air vibrations of the desired frequency (resonant frequency).

On the other hand, in the case in which configuration is performed using a member in which the wall part that forms the space part is soft and has high damping ability, capacity variation of the space part accompanying air vibrations of the interior is produced. For this reason, the resonant frequency of the Helmholtz resonator changes according to variations in the capacity of the space part. In addition, in such a case, the Helmholtz resonator damps air vibrations of a broad range of frequencies including the desired frequency (resonant frequency). Note that damping of the air vibrations in this case becomes weaker in comparison with the case in which the rigidity of the wall part that forms the space part is high.

That is, in the Helmholtz vibrator, in the case in which the rigidity of the wall part that forms the space part is high, the frequency component of the air vibrations that match a prescribed resonant frequency is strongly damped, and, in the case in which the wall part that forms the space part is soft and has high damping ability, a broad range of frequency components including the prescribed resonant frequency is weakly damped.

The resonance apparatus 1 of the present embodiment comprises a lid part 41 comprising a film-shaped member. Specifically, a part of the space S is comprised by a film-shaped member, so it is the same as the case in which, from when discussing the Helmholtz resonator, the space part is soft and has a high damping ability. Therefore, according to the resonance apparatus 1 of the present embodiment, it is possible to weakly damp a broadband of frequency components including the prescribed resonant frequency.

In the above, embodiments of the present invention were described, but the combination of the operating procedures and the various shapes of the respective constituent elements indicated in the embodiments discussed above are only examples, and various changes are possible based on design requirements, etc. within a scope in which the gist of the present invention will not be deviated from.

For example, in the above embodiments, a configuration in which the column 30 comprises the resonance apparatus 1 was described. However, the present invention is not limited to this, and the configuration may also be such that another support structure (base plate 38, etc.) that is not limited to the column 30 comprises the resonance apparatus. In such a case, there is a possibility that the support structure will not include a cast metal member, so a resonance apparatus that separately forms a recessed part in the support structure may be configured by means of said recessed part, the lid part 4 and the orifice 5.

In the above embodiment, the noise produced by the machine chamber 70 and the blower 64 operating was described as an example of the air vibrations transmitted from the exterior. However, the present invention is not limited to this, and it is effective with respect to all sound transmitted from the exterior of the column 30. That is, it is possible to restrict vibration attributable to sound transmitted to the interior of the exposure apparatus EX from the exterior of the exposure apparatus EX.

In the above embodiments, a configuration in which the lid part 4, 41 comprised by the resonance apparatus 1 covers the entirety of the recessed part 3 of the column 30 was described. However, the present invention is not limited to this, and it may also be a configuration in which the lid part 4, 41 covers a part of the recessed part 3.

In addition, in the above embodiments, a configuration in which the entire lid part comprised by the resonance apparatus 1 is comprised of a film-shaped member was described. However the present invention is not limited to this, and it may also be a configuration in which a part of the lid part is comprised by a film-shaped member.

In the above embodiments, the case in which a KrF excimer laser, an ArF excimer laser, etc. were used as the light source was described, but it is not limited to this, and an F2 laser or an Ar2 laser may also be used as the light source, or a metal vapor laser or a YAG laser may be used, or a higher harmonic wave of these may be used as the exposure illumination light. Or, one may use as the exposure illumination light a higher harmonic wave in which infrared band or visible band single wavelength laser light oscillated from a DFB semiconductor laser or a fiber laser is amplified by a fiber amp that has been doped with, for example, erbium (or both erbium and ytterbium (Yb)) and wavelength converted to ultraviolet light using a nonlinear optical crystal.

In addition, in the above embodiments, a step-and-repeat system exposure apparatus was described as an example, but the present invention may also be applied to a step-and-scan system exposure apparatus. Furthermore, the present invention may be applied not only to exposure apparatuses used in the manufacture of semiconductor devices but also to the manufacture of exposure apparatuses used in the manufacture of displays including liquid crystal display elements (LCD) that transfer a display pattern onto a glass plate, exposure apparatuses used in the manufacture of thin-film magnetic heads that transfer a display pattern onto a ceramic wafer, and exposure apparatuses used in the manufacture of image pickup elements such as CCDs.

In addition, the projection optical system 16 may be any of a dioptric system, a catadioptric system or a catoptric system and may be any of a reduction system, a unity magnification system or an enlargement system.

Furthermore, the present invention can also be applied to exposure apparatuses that transfer a circuit pattern to glass substrates, silicon wafers, etc. in order to manufacture reticles or masks used in optical exposure apparatuses, EUV exposure apparatuses, x-ray exposure apparatuses and electron beam exposure apparatuses. Here, in exposure apparatuses that use DUV (deep ultraviolet) light or VUV (vacuum ultraviolet) light, in general, transmittance type reticles are used, and, quartz glass, quartz glass doped with fluorine, fluorite, magnesium fluoride or liquid crystal is used for the reticle substrate. Also, in proximity system x-ray exposure apparatuses or electron beam exposure apparatuses, transmittance type masks (stencil masks, membrane masks) are used, and a silicon wafer, etc. is used as the mask substrate.

Note that such exposure apparatuses are disclosed in, for example, WO99/34255, WO99/50712, WO99/66370, Japanese Patent Application Publication No. H11-194479A, Japanese Patent Application Publication No. 2000-12453A and Japanese Patent Application Publication No. 2000-29202A.

In addition, the present invention, after appropriately implementing the necessary liquid countermeasures, can also be applied to liquid immersion exposure apparatuses that form a prescribed pattern on a substrate via a liquid supplied between projection optical system and substrate (wafer). Examples of structure and exposure operation of the liquid immersion exposure apparatus are disclosed in, for example, PCT International Publication No. WO 99/49504, Japanese Patent Application Publication No. H6-124873A and Japanese Patent Application Publication No. H10-303A.

The present invention can also be applied to a twin stage type exposure apparatus. The structure and exposure operations of a twin stage type exposure apparatus are disclosed in, for example, Japanese Patent Application Publication No. H10-163099A, Japanese Patent Application Publication No. H10-214783A, Published Japanese Translation No. 2000-505958 of PCT International Application, and U.S. Pat. No. 6,208,407. In addition, as disclosed in Japanese Patent Application Publication No. H11-135400A, the present invention is also applicable to an exposure apparatus that comprises an exposure stage that holds a substrate to be processed, such as a wafer and is able to move and a measuring stage that comprises various measuring members and sensors.

In addition, the exposure apparatus to which the present invention is applied is not limited to those that use a light transmitting type mask in which a prescribed light shielding pattern (or phase pattern/light reduction pattern) has been formed on a light transmissive substrate or a light reflecting type mask in which a prescribed reflection pattern is formed on a light reflective substrate but may also be an exposure apparatus that uses an electronic mask that forms a transmission pattern or a reflection pattern or a light emission pattern based on electronic data of the pattern to be exposed, such as that disclosed in U.S. Pat. No. 6,778,257, for example.

In addition, in the above embodiments, the support structure of the present invention was given a configuration applicable to exposure apparatuses, but, in addition to exposure apparatuses, it is also applicable to transfer mask writing apparatuses and precision measuring equipment such as mask pattern position coordinate measuring apparatuses.

The reaction force generated by the movement of the reticle stage may be caused to mechanically escape to the floor (ground) using a frame member so that it is not transmitted to the projection optical system, as described in Japanese Patent Application Publication No. H8-330224A (corresponds to U.S. Pat. No. 5,874,820).

In addition, the reaction force generated by the movement of the wafer stage may be caused to mechanically escape to the floor (ground) using a frame member so that it is not transmitted to the projection optical system, as described in Japanese Patent Application Publication No. H8-166475A (corresponds to U.S. Pat. No. 5,528,126).

Next, an embodiment of a micro device manufacturing method in which the exposure apparatuses and exposure methods resulting from the embodiments of the present invention are used in a lithography process will be described.

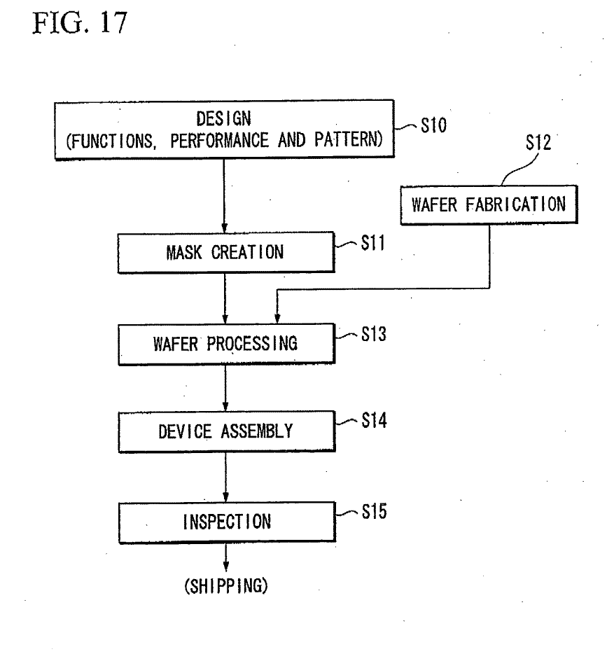

FIG. 17 is a drawing that shows a flow chart of an example of manufacturing of a micro device (a semiconductor chip such as an IC or LSI, a liquid crystal panel, CCD, micromachine, MEMS, DNA chip, thin-film magnetic head, micromachine, etc.).

First, in step S10 (design step), function and performance design of a microdevice are performed (for example, circuit design of a semiconductor device), and pattern design for achieving those functions is performed. Then, in step S11 (mask creation step), a mask (reticle) on which the designed circuit pattern is formed is created. While, in step S12 (wafer fabrication step), a wafer is fabricated using a material such as silicon.

Next, in step S13 (wafer processing step), the mask and wafer prepared in step S10 to step S12 are used to form the actual circuit on the wafer, etc. by lithography technology, etc. as discussed below. Next, in step S14 (device assembly step), the wafer processed in step S13 is used to perform device assembly. In this step S14, processes such as a dicing process, a bonding process, and a packaging process (chip sealing) are included as necessary. Lastly, in step S15 (inspection step), inspections such as an operation confirmation test and a durability test for the microdevice manufactured in step S14 are performed. Having passed through these processes, the microdevices are completed, and these are shipped.

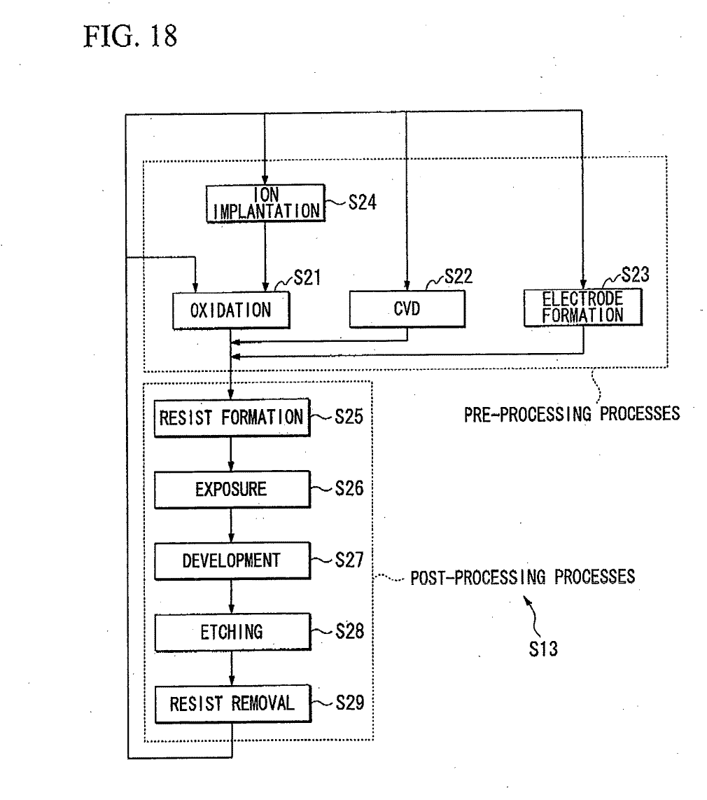

FIG. 18 is a drawing that shows an example of the detailed flow of step S13 in the case of a semiconductor device.

The surface of the wafer is oxidized in step S21 (oxidation step). In step S22 (CVD step), an insulation film is formed on the wafer surface. In step S23 (electrode formation step), an electrode is formed on the wafer by vapor deposition. In step S24 (ion implantation step), ions are implanted in the wafer. The respective steps above, step S21 to step S24, constitute the pre-processing processes of the respective stages of wafer processing, and they are selected and executed according to the processes required for the respective stages.

In the respective stages of the wafer process, when the above pre-processing processes have ended, post-processing processes are executed in the following way. In these post-processing processes, first, in step S25 (resist formation step), the wafer is coated with a photosensitive agent. Then, in step S26 (exposure step), the circuit pattern of the mask is transferred to the wafer by the lithography system (exposure apparatus) and exposure method described above. Then, in step S27 (development step), the exposed wafer is developed, and, in step S28 (etching step), the exposed members of portions other than the portions where resist remains are removed by etching, Then, in step S29 (resist removal step), etching is completed, and the resist that has become unnecessary is removed. By repeatedly performing these pre-processing processes and post-processing processes, circuit patterns are multiply formed onto the wafer.

In addition, the present invention can also be applied not only to microdevices such as semiconductor devices but to manufacture of reticles or masks used in optical exposure apparatuses, EUV exposure apparatuses, x-ray exposure apparatuses and electron beam exposure apparatuses, etc.

Note that insofar as it is permitted by law, the disclosures of all publications and US patents relating to the exposure apparatuses, etc. cited in the above respective embodiments and modification examples will be invoked and considered a part of the descriptions of the present document.

What is claimed is:

1. A support structure that supports a support object, comprising:
a resonance apparatus that resonates with air vibrations transmitted from an exterior to damp the air vibrations.

2. A support structure according to claim 1, wherein the resonance apparatus damps the air vibrations by means of Helmholtz resonance.

3. A support structure according to claim 1, wherein
the resonance apparatus comprises a recessed part formed on the support structure,
a lid part that covers a part of or an entirety of the recessed part, and
a neck part that has a narrow path that connects the space covered by the lid part with an external space.

4. A support structure according to claim 3, wherein
the support structure includes a cast metal member, and at least a part of or an entirety of the wall surface of the recessed part is formed by the cast metal member.

5. A support structure according to claim 4, wherein at least one of the space and the narrow path is formed using specifications according to the frequency of the air vibrations.

6. A support structure according to claim 3, wherein
the neck part is freely attachably and removably fixed to the lid part.

7. A support structure according to claim 3, wherein
the neck part is fixed so that an angle of the direction of the narrow path with respect to the lid part freely varies.

8. A support structure according to claim 3, wherein
the neck part is installed so that the narrow path direction faces the amplitude direction of the air vibrations.

9. A support structure according to claim 3, wherein the capacity of the space covered by the lid part is adjustable.

10. A support structure according to claim 9, further comprising:
an adjustment member, which is for adjusting the capacity of the space covered by the lid part,
a part of the space is filled by means of the adjustment member.

11. A support structure according to claim 9, further comprising:
a partition plate that comprises an adjustment member, which is for adjusting the capacity of the space covered by the lid part, and that partitions a part of the space by means of the adjustment member.

12. A support structure according to claim 9, wherein the capacity of the space is adjusted by means of an insertion member that is supported by the lid part and is able to adjust the amount of insertion into the space covered by the lid part.

13. A support structure according to claim 12, wherein the insertion member and the neck part are formed as a unit.

14. A support structure according to claim 3, wherein at least a part of the lid part is formed by a film-shaped member.

15. A support structure according to claim 1, wherein the resonance apparatus is installed at a position corresponding to a thick part of the air vibrations.

16. A support structure according to claim 1, wherein the resonance apparatus is plurally comprised.

17. A support structure according to claim 16, comprising resonance apparatuses of different resonant frequencies.

18. An exposure apparatus that exposes an image of a pattern to a substrate using a support object supported by a support structure; wherein
a support structure according to claim 1 is used as the support structure.
